(19) United States
(12) Patent Application Publication
(10) Pub. No.: US 2012/0079307 A1
(43) Pub. Date: Mar. 29, 2012

(54) PSU Self-Test

(76) Inventor: Donald A. LIEBERMAN, San Jose, CA (US)

(21) Appl. No.: 12/891,661

(22) Filed: Sep. 27, 2010

(51) Int. Cl. G06F 1/26

(52) U.S. Cl. 713/340; 713/300

(57) ABSTRACT

A method and apparatus for testing a power supply unit is disclosed. One aspect of certain embodiments includes a test activation mechanism that is internal to the power supply unit for shorting an active-low, power-on signal to ground and for monitoring a power-good signal intended for the computer.

### TECHNICAL FIELD

The disclosed embodiments relate generally to power supply units. More particularly, the disclosed embodiments relate to methods and apparatus for testing a power supply unit.

### BACKGROUND

Power supply units (PSU) need to be able to supply various voltages for proper operation of computers. For example, an end user purchases a PSU for incorporation into the end user's home-assembled computer. The malfunction of PSU's can cause considerable damage to the computers to which the PSU's supply current. Typically, the end user has only one indication that the PSU may be functioning properly which is a spinning cooling fan in the PSU. Moreover, the spinning fan does not mean that the PSU is fault-free in one or more aspects of its operation. This cooling fan spins only after the PSU is connected to the motherboard of the computer. As a result, the motherboard could be damaged upon connection to a malfunctioning PSU. Thus, the PSU needs a stand alone self-contained monitoring system that is cost effective and that indicates to the end-user that the PSU is functioning properly without requiring that the PSU be connected to the computer.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating logical components for self-testing of a power supply unit (PSU), according to certain embodiments.

FIG. 2 is a block diagram illustrating logical components for self-testing of a power supply unit (PSU) based on a Power Good signal whenever the PSU is connected to the computer, according to certain embodiments.

FIG. 3 is a high-level flow chart showing some of the steps for performing a self-test on a power supply unit for use with a computer, according to certain embodiments.

FIG. 4 is a high-level flow chart showing some of the steps for performing a self-test on a power supply unit for use with a computer, according to yet another embodiment.

### DESCRIPTION OF EMBODIMENTS

Methods, systems, apparatus, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

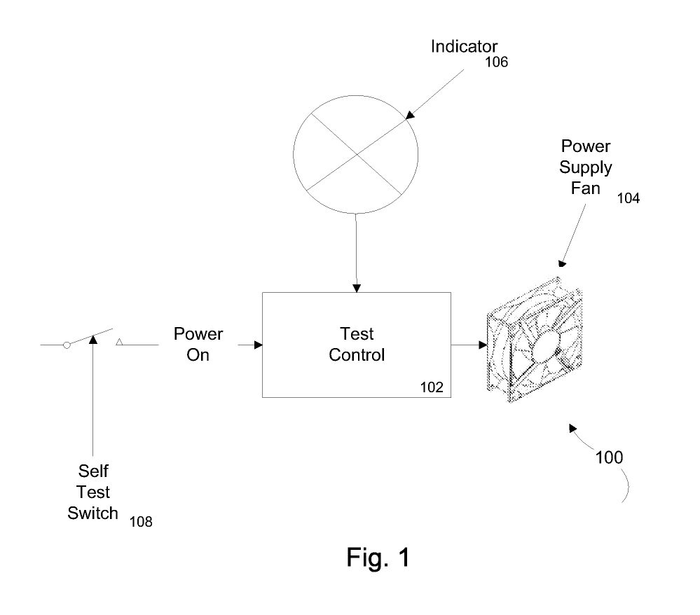

FIG. 1 is a block diagram illustrating logical components for self-testing of a power supply unit (PSU), according to certain embodiments. FIG. 1 shows that an ATX compatible PSU 100 includes a test control unit 102 that can be activated by a self test switch 108 and by supplying AC current to the PSU before installing the PSU into the computer to which the PSU is to supply power. The self test switch 108 can be implemented as a push button on the ATX compatible PSU, for example. As a non-limiting example, test control unit 102 can include a communication interface (not shown in FIG. 1) for receiving test activation information from a source external to PSU 100.

The ATX compatible PSU normally sends an ATX specification defined Power Good signal to the motherboard upon installing the PSU to the computer to which the PSU is supplying current. However, instead of installing the PSU to the computer, test control unit 102 can be configured to short an active-low, power-on signal to ground in order to buffer and monitor the Power Good signal, according to certain embodiments.

PSU 100 includes an indicator unit 106 and a cooling fan 104. Indicator unit 106 and cooling fan 104 are connected to test control unit 102. According to certain embodiments, indicator unit 106 can include indicator lights to indicate whether the PSU is operating properly based on a Power Good signal upon activating the test control unit 102 by closing the self test switch 108. For example, the indicator light may be red initially. The indicator light would turn green if the PSU is operating properly based on the Power Good signal upon activating the test control unit 102 by closing the self test switch 108 or by receiving test activation information from an external source through the communication interface on the PSU. In addition, cooling fan 104 can be configured to run for a predetermined period of time to indicate that the PSU is operating properly based on the Power Good signal upon activating the test control unit 102 by closing the self test switch 108 or by receiving test activation information from an external source through the communication interface on the PSU. According to certain embodiments, the rotational speed of cooling fan 104 can be modulated either up or down or both from a default operating speed at power-on to indicate that the PSU is operating properly based on the Power Good signal upon activating the test control unit 102 by closing the self test switch 108 or by receiving test activation information from an external source through the communication interface on the PSU. Similarly, the communication interface associated with the PSU can report the operating status of the PSU. Note that the above events occur before installing the PSU to the computer and are in response to the monitored Power Good signal captured by shorting an active-low, power-on signal to ground when the test control unit is activated.

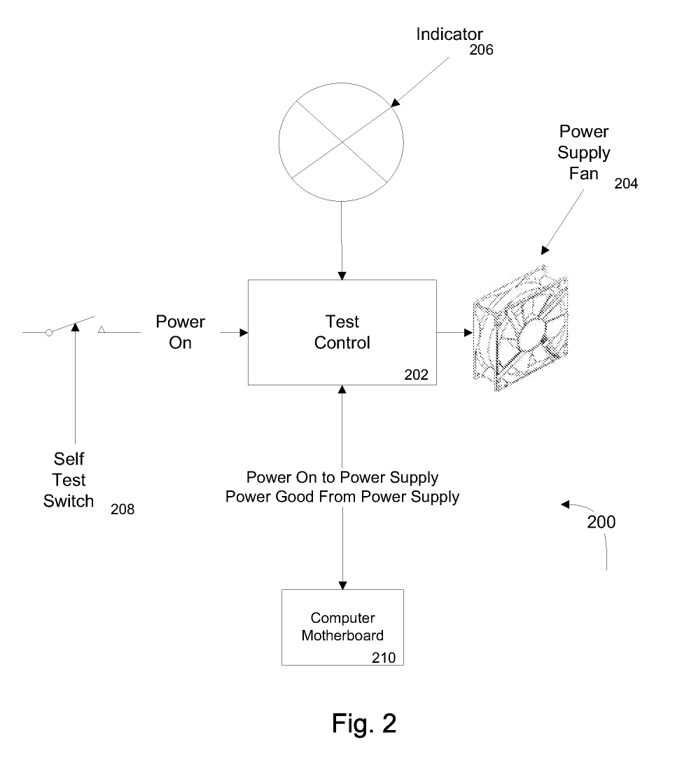

FIG. 2 is a block diagram illustrating logical components for self-testing of a power supply unit (PSU) based on a Power Good signal whenever the PSU is connected to the computer, according to certain embodiments. FIG. 2 shows that an ATX compatible PSU 200 includes a test control unit 202 that can be activated by a self test switch 208. The self test switch 208 can be implemented as a push button on the ATX compatible PSU, for example. As a non-limiting example, test control unit 202 can include a communication interface (not shown in FIG. 2) for showing PSU status information.

PSU 200 includes an indicator unit 206 and a cooling fan 204. Indicator unit 206 and cooling fan 204 are connected to test control unit 202. According to certain embodiments, test control unit is also connected to the motherboard 210 of the computer to which the PSU is supplying power. The ATX compatible PSU normally sends an ATX specification defined Power Good signal to the motherboard upon installing the PSU to the computer to which the PSU is supplying current.

According to certain embodiments, indicator unit 206 can include indicator lights to indicate whether the PSU is operating properly based on the Power Good signal whenever the ATX PSU is connected to the motherboard. For example, the indicator light may be red initially. The indicator light would turn green if the PSU is operating properly based on the Power Good signal. As another example, the communication interface (not shown in FIG. 2) can show PSU status information based on monitoring the Power Good signal whenever the ATX PSU is connected to the motherboard. In addition, the rotational speed of cooling fan 204 can be modulated either up or down or both from an existing operating speed to indicate that the PSU is operating properly based on monitoring the Power Good signal whenever the ATX PSU is connected to the motherboard and when the test control unit 202 is activated by closing the self test switch 208 (by using a push button, for example) or by receiving test activation information from an external source through the communication interface on the PSU, as previously described with respect to FIG. 1.

In addition to the above features based on monitoring the Power-good signal, indicator unit 206 can include indicator lights to indicate whether the PSU is operating properly upon activating the test control unit 202 by closing the self test switch 208 (by using a push button, for example), as previously described with respect to FIG. 1. For example, the indicator light may be red initially. The indicator light would turn green if the PSU is operating properly upon activating the test control unit 202 by closing the self test switch 208 or by receiving test activation information from an external source through the communication interface on the PSU.

According to certain other embodiments, the self-test systems described above with respect to FIG. 1 and FIG. 2 can also include a plug-in module (not shown in the figures) that plugs into a connector of the ATX compatible PSU. The use of a plug-in model allows for testing of the PSU without having to install the PSU to the computer assembly to which the PSU is to supply power. As a non-limiting example, the plug-in module can be configured to trigger a series of current loads for each voltage source in the ATX compatible power supply unit for a set period of time. The series of current loads for each voltage source can be set dynamically and independently of each other. Further, the series of current loads are enabled by activating one or more of: MOSFETs, bipolar transistors or relays. In response to the series of current loads, indicator unit (106, 206) can activate indicator lights to show the status of the PSU. Similarly, a communication interface can report the status of the PSU in response to the series of current loads.

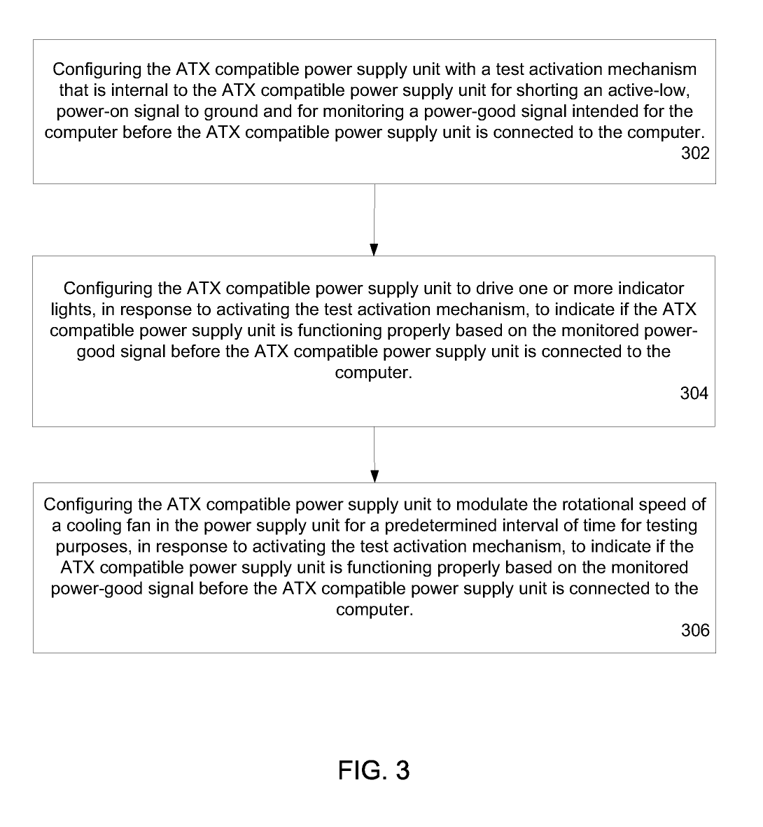

FIG. 3 is a high-level flow chart showing some of the steps for performing a self-test on a power supply unit for use with a computer, according to certain embodiments. At block 302, the ATX compatible power supply unit is configured with a test activation mechanism that is internal to the ATX compatible power supply unit for shorting an active-low, power-on signal to ground and for monitoring a power-good signal intended for the computer before the ATX compatible power supply unit is connected to the computer.

At block 304, the ATX compatible power supply unit is configured to drive one or more indicator lights, in response to activating the test activation mechanism, to indicate if the ATX compatible power supply unit is functioning properly based on the monitored power-good signal before the ATX compatible power supply unit is connected to the computer.

At block 306, the ATX compatible power supply unit is configured to modulate the rotational speed of a cooling fan in the power supply unit for a predetermined interval of time for testing purposes, in response to activating the test activation mechanism to indicate if the ATX compatible power supply unit is functioning properly based on the monitored power-good signal before the ATX compatible power supply unit is connected to the computer.

For example, the rotational speed of the cooling fan can be modulated either up or down or both from a default operating speed at power-on.

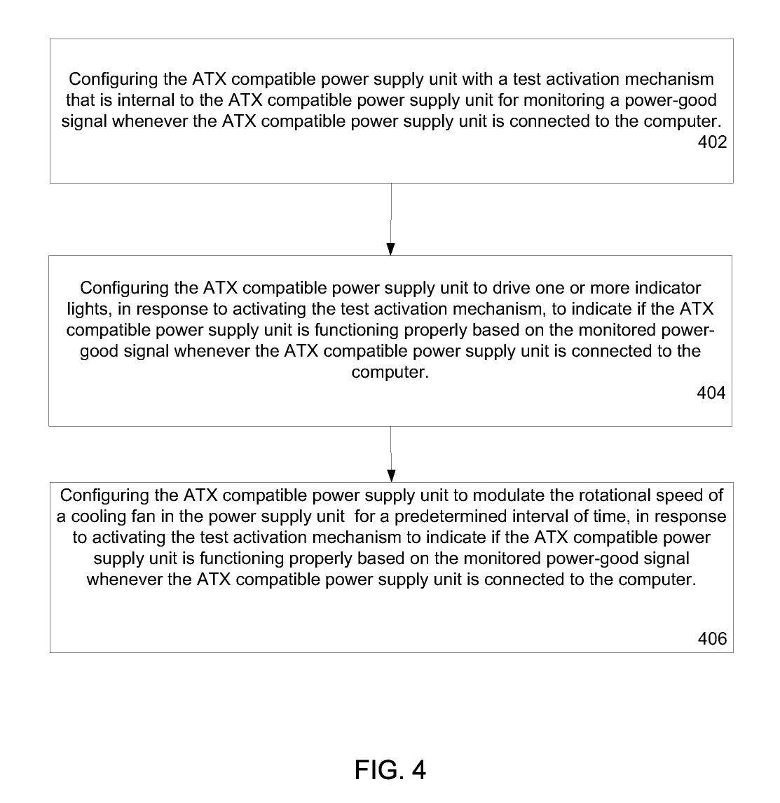

FIG. 4 is a high-level flow chart showing some of the steps for performing a self-test on a power supply unit for use with a computer, according to yet another embodiment. At block 402, the ATX compatible power supply unit is configured with a test activation mechanism that is internal to the ATX compatible power supply unit for monitoring a power-good signal whenever the ATX compatible power supply unit is connected to the computer.

At block 404, the ATX compatible power supply unit is configured to drive one or more indicator lights, in response to connecting the ATX power supply unit to the computer, to indicate if the ATX compatible power supply unit is functioning properly based on the monitored power-good signal whenever the ATX compatible power supply unit is connected to the computer.

At block 406, the ATX compatible power supply unit is configured to modulate the rotational speed of a cooling fan in the power supply unit for a predetermined interval of time in response to activating the test activation mechanism to indicate if the ATX compatible power supply unit is functioning properly based on the monitored power-good signal whenever the ATX compatible power supply unit is connected to the computer.

For example, the rotational speed of the cooling fan can be modulated either up or down or both from an existing operating speed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A method for managing an ATX compatible power supply unit for use with a computer, the method comprising:
enabling testing the ATX compatible power supply unit before connecting to the computer;
wherein enabling testing includes configuring the ATX compatible power supply unit with a test activation mechanism that is internal to the ATX compatible power supply unit for shorting an active-low, power-on signal to ground and for monitoring a power-good signal intended for the computer.

2. The method of claim 1, further comprising configuring the ATX compatible power supply unit to drive one or more indicator lights, in response to activating the test activation mechanism, to indicate if the ATX compatible power supply unit is functioning properly based on the monitored power-good signal.

3. The method of claim 1, further comprising configuring the ATX compatible power supply unit to modulate the rotational speed either up or down or both from a default operating speed at power-on of a cooling fan in the power supply unit to run for a predetermined interval of time for testing purposes, in response to activating the test activation mechanism.

4. The method of claim 1, wherein the test activation mechanism further includes a push button for activation.

5. The method of claim 1, wherein the test activation mechanism includes a communication interface for one or more of: receiving activation information from an external source, and reporting status information of the ATX compatible power supply unit.

6. A method for managing an ATX compatible power supply unit for use with a computer, the method comprising:
enabling testing the ATX compatible power supply unit when the ATX compatible power supply unit is connected to the computer;
wherein enabling testing includes configuring the ATX compatible power supply unit for monitoring a power-good signal of the ATX compatible power supply unit and indicating a status of the monitored power-good signal whenever the ATX compatible power supply unit is connected to the computer.

7. The method of claim 6, wherein indicating a status of the monitored power-good signal further comprising configuring the ATX compatible power supply unit to drive one or more indicator lights to indicate if the ATX compatible power supply unit is functioning properly based on the monitored power-good signal, in response to connecting the ATX compatible power supply unit to the computer.

8. The method of claim 6, further comprising configuring the ATX compatible power supply unit with a test activation mechanism that is internal to the ATX compatible power supply unit for shorting an active-low, power-on signal to ground and for monitoring the power-good signal.

9. The method of claim 8, wherein the test activation mechanism further includes a push button for activation.

10. The method of claim 8, wherein the test activation mechanism includes a communication interface for one or more of: receiving activation information from an external source, and reporting status information of the ATX compatible power supply unit.

11. The method of claim 8, further comprising configuring the ATX compatible power supply unit to drive one or more indicator lights, in response to activating the test activation mechanism, to indicate if the ATX compatible power supply unit is functioning properly based on the monitored power-good signal.

12. The method of claim 8, further comprising configuring the ATX compatible power supply unit to modulate the rotational speed of a cooling fan in the power supply unit either up or down or both from an existing operating speed for a predetermined interval of time for testing purposes, in response to activating the test activation mechanism to indicate if the ATX compatible power supply unit is functioning properly based on the monitored power-good signal.

13. A method for managing an ATX compatible power supply unit for use with a computer, the method comprising:
enabling testing the ATX compatible power supply unit before connecting to the computer;
wherein enabling testing includes configuring the ATX compatible power supply unit for using a plug-in module that plugs into a connector of the ATX compatible power supply unit, the plug-in module configured to trigger a series of current loads for each voltage source in the ATX compatible power supply unit for a set period of time, the series of current loads for each voltage source capable of being set dynamically and independently of each other.

14. The method of claim 13, wherein the series of current loads are enabled by activating one or more of: MOSFETs, bipolar transistors or relays.

15. The method of claim 13, wherein the ATX compatible power supply unit is further configured to activate one or more indicator lights on the ATX compatible power supply unit to indicate that the ATX compatible power supply unit is functioning properly in response to the series of current loads.

16. The method of claim 13, wherein the ATX compatible power supply unit is further configured with a communication interface for one or more of: receiving activation information from an external source, and reporting status information of the ATX compatible power supply unit.

17. An ATX compatible power supply unit for use with a computer, the ATX compatible power supply unit comprising:
one or more indicator lights;
a cooling fan;
a test activation mechanism;
wherein the ATX compatible power supply unit is configured for shorting an active-low, power-on signal to ground and for monitoring a power-good signal intended for the computer in response to activating the test activation mechanism.

18. The ATX compatible power supply unit of claim 17, wherein the ATX compatible power supply unit is further configured to drive the one or more indicator lights to indicate if the ATX compatible power supply unit is functioning properly based on the monitored power-good signal, in response to activating the test activation mechanism.

19. The ATX compatible power supply unit of claim 17, wherein the ATX compatible power supply unit is further configured to modulate the rotational speed of a cooling fan in the power supply unit either up or down or both from a default operating speed at power-on for a predetermined interval of time for testing purposes, in response to activating the test activation mechanism.

20. The ATX compatible power supply unit of claim 17, wherein the test activation mechanism further includes a push button for activation.

21. The ATX compatible power supply unit of claim 17, wherein the test activation mechanism includes a communication interface for one or more of: receiving activation information from an external source, and reporting status information of the ATX compatible power supply unit.

22. An ATX compatible power supply unit for use with a computer, the ATX compatible power supply unit comprising:
one or more indicator lights;
a cooling fan;
wherein the ATX compatible power supply unit is configured for monitoring a power-good signal in response to connecting the ATX compatible power supply unit to the computer.

23. The ATX compatible power supply unit of claim 22, wherein the ATX compatible power supply unit is further configured to drive the one or more indicator lights to indicate if the ATX compatible power supply unit is functioning properly based on the monitored power-good signal, in response to connecting the ATX compatible power supply unit to the computer.

24. The ATX compatible power supply unit of claim 22, further comprising a test activation mechanism wherein the ATX compatible power supply unit is configured for shorting an active-low, power-on signal to ground and for monitoring a power-good signal intended for the computer in response to activating the activation mechanism.

25. The ATX compatible power supply unit of claim 24, wherein the ATX compatible power supply unit is further configured to drive the one or more indicator lights to indicate if the ATX compatible power supply unit is functioning properly based on the monitored power-good signal, in response to activating the test activation mechanism

26. The ATX compatible power supply unit of claim 24, wherein the ATX compatible power supply unit is further configured to modulate the rotational speed of a cooling fan in the power supply unit either up or down or both from an existing operating speed for a predetermined interval of time for testing purposes, in response to activating the test activation mechanism to indicate if the ATX compatible power supply unit is functioning properly based on the monitored power-good signal.

27. The ATX compatible power supply unit of claim 24, wherein the test activation mechanism further includes a push button for activation.

28. The ATX compatible power supply unit of claim 24, wherein the test activation mechanism includes a communication interface for one or more of: receiving activation information from an external source, and reporting status information of the ATX compatible power supply unit.
